(19) United States
(12) Patent Application Publication
(10) Pub. No.: US 2026/0080268 A1
(43) Pub. Date: Mar. 19, 2026

(54) NON-TRANSITORY COMPUTER-READABLE MEDIUM, CALCULATION METHOD, AND INFORMATION PROCESSING DEVICE

(71) Applicant: Fujitsu Limited, Kawasaki-shi (JP)

(72) Inventor: Yuma ICHIKAWA, Kawasaki (JP)

(73) Assignee: Fujitsu Limited, Kawasaki-shi (JP)

(21) Appl. No.: 19/322,226

(22) Filed: Sep. 8, 2025

(30) Foreign Application Priority Data
Sep. 18, 2024 (JP) 2024-160810

(51) Int. Cl. G06N 5/01

(52) U.S. Cl. CPC G06N 5/01

(57) ABSTRACT

There is provided a non-transitory computer-readable medium storing a calculation program for causing a computer to execute a process. The process includes, in searching for a solution using a cost function and a penalty term obtained by introducing continuous relaxation into a discrete optimization problem, changing a penalty coefficient of the penalty term by using a gradient of the cost function and a gradient of the penalty term.

### CROSS-REFERENCE TO RELATED APPLICATION

This application is based upon and claims the benefit of priority of Japanese Patent Application No. 2024-160810 filed on Sep. 18, 2024, the entire contents of which are incorporated herein by reference.

### FIELD

A certain aspect of the present embodiments relates to a non-transitory computer-readable medium, a calculation method, and an information processing device.

### BACKGROUND

A technique has been disclosed for searching for a solution to a combinatorial optimization problem using a continuous relaxation method (see, for example, Ichikawa, Y. (2023). Controlling continuous relaxation for combinatorial optimization. arXiv preprint arXiv: 2309.16965.).

### SUMMARY

According to an aspect of the present disclosure, there is provided a non-transitory computer-readable medium storing a calculation program for causing a computer to execute a process, the process including: in searching for a solution using a cost function and a penalty term obtained by introducing continuous relaxation into a discrete optimization problem, changing a penalty coefficient of the penalty term by using a gradient of the cost function and a gradient of the penalty term.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF THE DRAWINGS

FIG. 1 illustrates validation results;

FIG. 2A is a functional block diagram of an overall configuration of an information processing device according to an embodiment;

FIG. 2B is a hardware configuration diagram of an information processing device;

FIG. 3 is a flowchart of an example of an operation of an information processing device during machine learning; and

FIG. 4 is a flowchart of an example of an operation of an information processing device when outputting an approximate solution to an optimization problem using results of machine learning model.

### DESCRIPTION OF EMBODIMENTS

The above-mentioned continuous relaxation solution method has been considered for constrained combinatorial optimization. However, it is difficult to appropriately adjust the penalty coefficient of the penalty term.

Optimization problems exist in various industries, including the manufacturing and distribution industries. In particular, combinatorial optimization problems, which optimize combinations, are one of the most important fields in the field of optimization. Combinatorial optimization problems are applied in various fields, such as transportation, logistics, communication, and finance.

Constrained combinatorial optimization problems are the most important problem in combinatorial optimization, and have many practical applications. For example, general-purpose solvers such as Ising machines use the penalty method to search for constraint-satisfying solutions. However, general-purpose solvers have difficulty finding a solution depending on the penalty coefficient. In addition, with local transition algorithms such as Ising machines, it is difficult to search for only local solutions, so it is difficult to obtain multiple solutions at once.

Here, we will provide an overview of constrained combinatorial optimization problems. First, we will explain the penalty method. Constrained optimization problems are expressed by the following formula (1). In general, in f(x;A), “x” represents the variable to be optimized, and “A” represents a constant that is not the object of optimization. Therefore, in the following formula (1), “C” represents a constant and is a parameter that characterizes the problem example. C is, for example, a graph G(V,E). x represents a variable, which is a vector represented by 0 and 1 and has N elements. Also, “s.t.” stands for “subject to”. “f” is represented by the following formula (2) and represents a cost function. The feasible region is represented by the following formula (3). The following formula (4) represents an equality constraint in the feasible region. The following formula (5) represents an inequality constraint in the feasible region.

$$\begin{matrix}[ Formula 1 ] & \\ {min}_{x ∈ {\{ 0 , 1 \}}^{N}} f ( x ; C ) s . t . x ∈ 𝒳 ( C ) & ( 1 )\end{matrix}$$

$$\begin{matrix}[ Formula 2 ] & \\ 𝒳 \times C \to ℝ & ( 2 )\end{matrix}$$

$$\begin{matrix}[ Formula 3 ] & \\ 𝒳 ( C ) = \{ x ∈ {\{ 0 , 1 \}}^{N} \vert ∀ i ∈ [ I ] , {g}_{i} ( x ; C ) \leq 0 , ∀ j ∈ [ J ] , {h}_{j} ( x ; C ) = 0 \} & ( 3 )\end{matrix}$$

$$\begin{matrix}[ Formula 4 ] & \\ i ∈ [ I ] , {g}_{i} : {\{ 0 , 1 \}}^{N} \times C \to ℝ & ( 4 )\end{matrix}$$

$$\begin{matrix}[ Formula 5 ] & \\ j ∈ [ J ] , {h}_{j} : {\{ 0 , 1 \}}^{N} \times C \to ℝ & ( 5 )\end{matrix}$$

In the penalty method, constrained combinatorial optimization is considered as an optimization problem of the following formula (6). That is, the penalty method introduces a penalty term.

$$\begin{matrix}[ Formula 6 ] & \\ {min}_{x} l ( x ; C , λ ) , l ( x ; C , λ ) = f ( x ; C ) + {\sum }_{i = 1}^{I + J} {λ}_{i} {v}_{i} ( x ; C ) & ( 6 )\end{matrix}$$

The following formula (7) is the penalty term, which is typically defined as the following formula (8) and formula (9).

$$\begin{matrix}[ Formula 7 ] & \\ i ∈ [ I + J ] , v : {\{ 0 , 1 \}}^{N} \times C ⟶ ℝ & ( 7 )\end{matrix}$$

$$\begin{matrix}[ Formula 8 ] & \\ ∀ i ∈ [ I ] , {v}_{i} ( x ; C ) = max ( 0 , {g}_{i} ( x ; C ) ) [ Inequality ] & ( 8 )\end{matrix}$$

$$\begin{matrix}[ Formula 9 ] & \\ ∀ j ∈ [ J ] , {v}_{j} ( x ; C ) = {( {h}_{j} ( x ; C ) )}^{2} [ Equality ] & ( 9 )\end{matrix}$$

In the following formula (10), “A” is a penalty coefficient, which is a parameter for controlling the balance between the cost function and the penalty term. The penalty method requires that the penalty coefficient be appropriately adjusted.

$$\begin{matrix}[ Formula 10 ] & \\ λ = {( {λ}_{i} )}_{l \leq i \leq I + J} ∈ {ℝ}^{I + J} & ( 10 )\end{matrix}$$

In the above penalty methods, it is difficult to adjust the parameter 2. For example, if A is too large, the solution being searched for is likely to be a local solution, and if A is too small, the solution being searched for is likely to violate the constraints.

Next, combinatorial optimization using machine learning will be described. Along with the development of information science, technology that aims to solve combinatorial optimization problems quickly using machine learning has been developed. One of these technologies is an optimization solution method using the continuous relaxation solution method.

The continuous relaxation solution method is a method of approximately solving a combinatorial optimization problem as a continuous optimization problem. Instead of solving a discrete optimization problem, it is a method of relaxing the discrete optimization problem and solving a continuous optimization problem corresponding to the discrete optimization problem. A continuous optimization problem can be expressed as in the following formula (11). In the following formula (11), [0, 1]^{N} represents an N-dimensional hypercube lattice that takes the value 0 or 1. In the following formula (11), the variable vector p is the variable to be optimized.

$$\begin{matrix}[ Equation 11 ] & \\ {min}_{p ∈ [ 0 , 1 ] N} \hat{l} ( p ; C , λ ) , \hat{l} ( p ; C , λ ) = \hat{f} ( p ; C ) + {\sum }_{i = 1}^{m + p} {λ}_{i} {\hat{v}}_{i} ( p ; C ) & ( 11 )\end{matrix}$$

In the above formula (11), the following formula (12) is generally converted to the following formula (13) for any x∈{0,1}^{N}.

$$\begin{matrix}[ Equation 12 ] & \\ \hat{f} : {[ 0 , 1 ]}^{N} \times C \to ℝ & ( 12 )\end{matrix}$$

$$\begin{matrix}[ Equation 13 ] & \\ \hat{f} ( x ; C ) = f ( x ; C ) & ( 13 )\end{matrix}$$

However, even when using the continuous relaxation solution method, it is still difficult to adjust the penalty coefficient λ.

Therefore, in the following embodiment, an example in which the penalty coefficient λ can be appropriately adjusted will be described.

(Embodiment) First, the principle of this embodiment will be described. In this embodiment, in optimization using the continuous relaxation solution method, the penalty coefficient of the optimization process is updated sequentially using the gradient of the cost function and the penalty term in the continuous relaxation. For example, the penalty coefficient λ in the above formula (11) is changed in the solution process using the gradient of the cost function and the gradient of the penalty term in the following formula (15) which is continuously relaxed as the following formula (14).

$$\begin{matrix}[ Formula 14 ] & \\ {λ}^{t + 1} ⟵ {Γ}_{t} ( {λ}^{t} \cdot \frac{\partial \hat{f} ( p : C )}{\partial p} {\vert}_{p = {p}^{t}} \cdot {\{ \frac{\partial {\hat{v}}_{i} ( p : C )}{\partial p} {\vert}_{p = {p}^{t}} \}}_{i = 1}^{I + J} ) & ( 14 )\end{matrix}$$

$$\begin{matrix}[ Formula 15 ] & \\ \hat{f} ( p ; C ) , ∀ i ∈ [ I , J ] , {\hat{v}}_{i} ( p ; C ) & ( 15 )\end{matrix}$$

In the above formula (14), t∈[T] represents the time that characterizes one step, which is each solution process, and satisfies the following formula (16).

$$\begin{matrix}[ Formula 16 ] & \\ Γ : [ T ] \times {ℝ}^{2 N} \times {ℝ}^{I + J} \to {ℝ}^{I + J} & ( 16 )\end{matrix}$$

If the variables are discrete, 0 and 1, the gradient of the cost function and the penalty term is obtained. However, the method of this embodiment uses continuous variables because the method uses the continuous relaxation method. Therefore, the gradient of the cost function and the penalty term can be obtained. In the above formula (14), the part of the following formula (17) holds information indicating whether or not the cost function and the penalty term are reduced by moving in a direction in the search space. Therefore, for example, by using the above formula (14), the penalty coefficient can be appropriately adjusted so that the cost function and the penalty term are reduced.

$$\begin{matrix}[ Formula 17 ] & \\ \frac{\partial \hat{f}}{\partial p} , \{ \frac{\partial {\hat{v}}_{i}}{\partial p} \} & ( 17 )\end{matrix}$$

For example, the case of annealing GNN will be described. GNN stands for Graph Neural Network. For example, when optimizing a relaxation variable vector “p” by parametrizing it with a GNN, the graph G of the optimization problem is converted into an embedding vector h(0)(G). “G” is the feature vector of the graph in the GNN. For a combinatorial optimization problem on the graph G, the relaxation variable p is characterized as p_{θ}(h⁽⁰⁾(G);G) using a GNN. In this way, in GNN, since the relaxation variable p is characterized by θ, the penalty coefficient is changed during learning, for example, as in the following formula (18).

$$\begin{matrix}[ Formula 18 ] & \\ {λ}^{t + 1} ⟵ {Γ}_{t} ( {λ}^{t} , \frac{\partial \hat{f} ( {p}_{θ} ; C )}{\partial θ} {\vert}_{θ = {θ}^{t}} , {\{ \frac{\partial {\hat{v}}_{i} ( {p}_{θ} ; C )}{\partial θ} {\vert}_{θ = {θ}^{t}} \}}_{i = 1}^{I + J} ) & ( 18 )\end{matrix}$$

Next, the above solution principle will be verified. Specifically, the Maximum Independent Set problem defined by the cost function of the following formula (19) when the number of variables (number of nodes) on Regular Random Graph G(V,E) is 1000 with degree d=20 will be verified. The degree d=20 and the number of nodes is 1000 means that there are 1000 nodes, and one node is randomly connected to 20 nodes. The penalty coefficient is changed as in the following formula (20) during the solution process. Note that each “t” is characterized by the update using the gradient descent method, and the initial value of λ, λ⁰, is set to λ⁰=0.

$$\begin{matrix}[ Equation 19 ] & \\ l ( x ; G , λ ) = - {\sum }_{i ∈ V} {x}_{i} + λ {\sum }_{( i , j ) ∈ E} {x}_{i} {x}_{j} & ( 19 )\end{matrix}$$

$$\begin{matrix}[ Equation 20 ] & \\ ∀ t ∈ ⌊ T ⌋ , {Γ}_{t} ( {λ}^{t} , \frac{\partial \hat{f} ( {p}_{θ} ; C )}{\partial θ} {\vert}_{θ = {θ}^{t}} , {\{ \frac{\partial {\hat{v}}_{i} ( {p}_{θ} ; C )}{\partial θ} {\vert}_{θ = {θ}^{t}} \}}_{i = 1}^{I + J} ) = \frac{1}{1 + \vert Mean ( {\{ \frac{\partial \hat{f} ( {p}_{θ} ; C )}{\partial {p}_{i , θ}} {\vert}_{θ = {θ}^{t}} \}}_{i = 1}^{N} ) \vert} & ( 20 )\end{matrix}$$

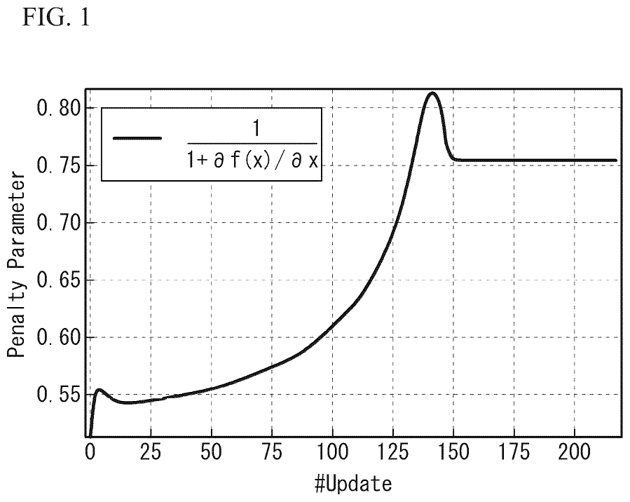

FIG. 1 is a diagram illustrating the verification results. Starting with the initial value λ⁰, the penalty coefficient λ was adaptively changed as illustrated in FIG. 1, and f(x;G)=−162 was achieved without violating any constraints. Note that the result of appropriately fine-tuning λ using various methods is f(x;G)=−167, so it can be seen that a performance equivalent to this case has been achieved.

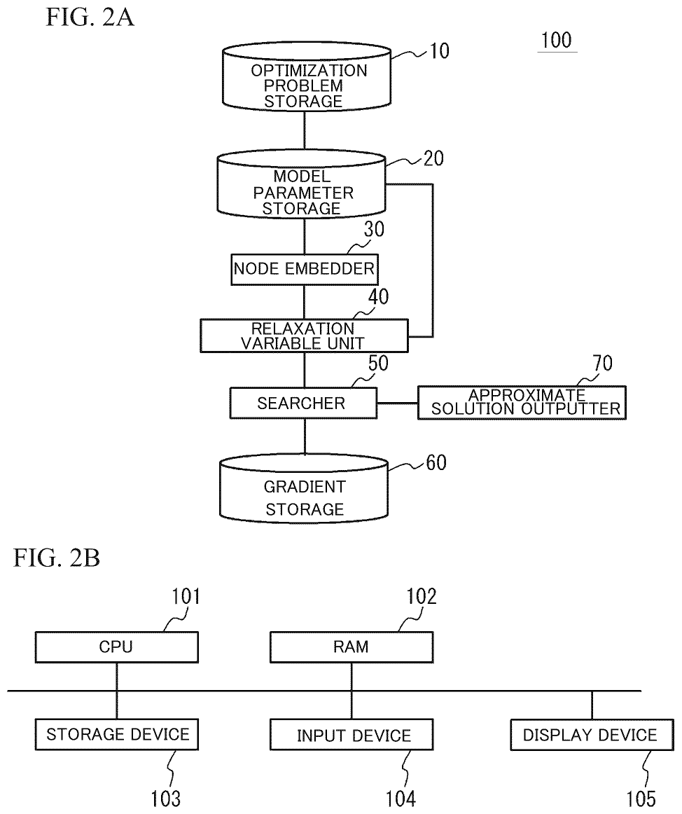

Next, the device configuration for realizing the above solution principle will be described. FIG. 2A is a functional block diagram of the overall configuration of an information processing device 100 according to the embodiment. The information processing device 100 is a server for optimization processing or the like. As illustrated in FIG. 2A, the information processing device 100 functions as an optimization problem storage 10, a model parameter storage 20, a node embedder 30, a relaxation variable unit 40, a searcher 50, a gradient storage 60, an approximate solution outputter 70 and so on.

For example, in the process of searching for a solution using a cost function and penalty term obtained by incorporating continuous relaxation into a discrete optimization problem, the searcher 50 uses the gradient of the cost function and penalty term to change the penalty coefficient of the penalty term.

Furthermore, for example, the searcher 50 uses the gradient to change the penalty coefficient so that the cost function and penalty term decrease.

Furthermore, for example, the searcher 50 uses a loss term in the cost function that corresponds to the degree of continuity and discreteness of the variable to be optimized, and changes the loss term as the search process progresses.

Furthermore, for example, as the search process progresses, the searcher 50 changes the loss term from one in which the loss is smaller the more continuous the variable is, to one in which the loss is larger the more continuous the variable is.

Furthermore, for example, the searcher 50 machine-learns the model by repeatedly changing the penalty coefficient of the penalty term, changing the model parameters of the model in which the discrete optimization problem is embedded, and calculating the cost function and penalty term.

FIG. 2B is a hardware configuration diagram of the information processing device 100. As illustrated in FIG. 2B, the information processing device 100 includes a CPU 101, a RAM 102, a storage device 103, an input device 104, a display device 105, and the like.

The CPU 101 is a central processing unit. The CPU 101 includes one or more cores. The RAM (Random Access Memory) 102 is a volatile memory that temporarily stores the program executed by the CPU 101 and the data processed by the CPU 101. The storage device 103 is a non-volatile storage device. For example, a ROM (Read Only Memory), a solid state drive (SSD) such as a flash memory, or a hard disk driven by a hard disk drive can be used as the storage device 103. The storage device 103 stores a machine-learning program and a determination program. The input device 104 is a device for a user to input necessary information, such as a keyboard or a mouse. The display device 105 is a display device that displays the sampling results output by the approximate solution outputter 70 on a screen. Each part of the information processing device 100 is realized by the CPU 101 executing the calculation program. Note that each part of the information processing device 100 may be hardware such as a dedicated circuit.

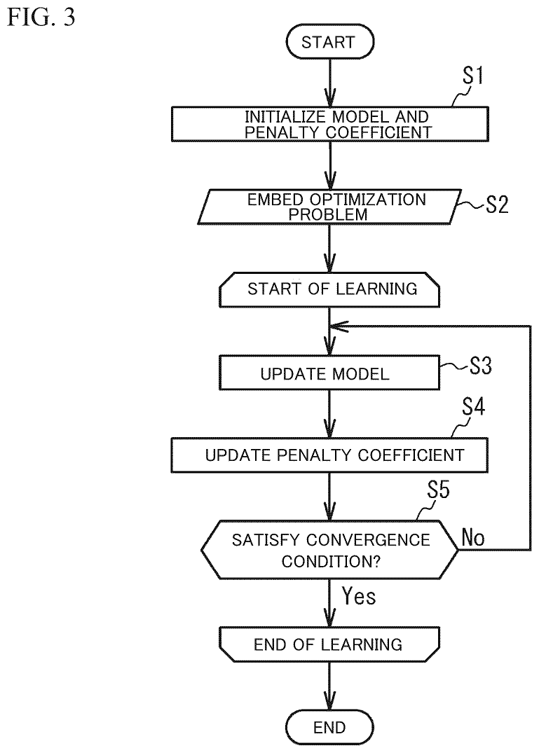

FIG. 3 is a flowchart of an example of the operation of the information processing device 100 during machine learning (training a model by machine learning). As illustrated in FIG. 3, the searcher 50 initializes the model and the penalty coefficient (step S1). Specifically, the searcher 50 sets the model parameters stored in the model parameter storage 20 to predetermined initial values, and sets the penalty coefficient to a predetermined initial value. For example, the model parameter is 0 in the above formula (18). The penalty coefficient is 2 in the above formulas (11) and (14).

Next, the node embedder 30 embeds the optimization problem (step S2). For example, in a problem using a graph, the node embedder 30 converts the graph feature vector of the given optimization problem into an embedding vector h_{φ,G}. The relaxation variable unit 40 sets the relaxed dynamic variables that are parameterized by the neural network. The node embedder 30 uses the penalty coefficients set to the initial values in step S1. This results in the loss function expressed by the above formula (15).

Next, the searcher 50 updates the model parameters by gradient descent (step S3). The searcher 50 updates the model parameters using the gradient stored in the gradient storage 60. When step S3 is executed for the first time, the model parameters are not updated.

Next, the searcher 50 updates the penalty coefficient according to the above formula (14) (step S4).

Next, the searcher 50 determines whether or not the convergence condition is satisfied (step S5). For example, it is determined whether or not the loss function of the above formula (15) is no longer smaller than a specified value even when step S4 is executed repeatedly. If the determination in step S5 is “No”, the process is executed again from step S3.

If the determination in step S5 is “Yes”, the execution of the flowchart ends. In this case, the model parameter storage 20 stores the model parameters when the loss function is smallest.

The machine learning in FIG. 3 can provide a machine learning model that minimizes the loss function of the above formula (15). The machine learning model (model parameters) are stored in the model parameter storage 20.

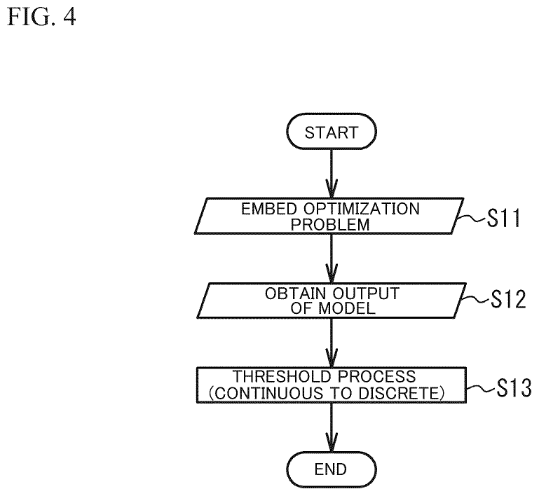

FIG. 4 is a flowchart of an example of the operation of the information processing device 100 when outputting an approximate solution to an optimization problem using the results of the machine learning model obtained by the machine learning illustrated in FIG. 3. As illustrated in FIG. 4, the node embedder 30 embeds the optimization problem (step S11).

Next, the approximate solution outputter 70 acquires the output of the machine learning model (step S12).

Next, the approximate solution outputter 70 performs threshold processing on the optimal solution output by the machine learning model (step S13). For example, a threshold is set for each value output by the machine learning model to convert the value into a binary value of 0 and 1. For example, when converting each value into a binary value of 0 and 1, the threshold is set to 0.5, and values greater than 0.5 are set to 1, and values less than 0.5 are set to 0.

(Modification) The continuous relaxation annealing method may be applied to the continuous relaxation solution method described above. In the continuous relaxation annealing method, the variable p is parameterized by a statistical model, and the loss function of the following formula (21) is optimized.

$$\begin{matrix}[ Formula 21 ] & \\ \hat{r} ( {p}_{θ} ; C , λ , γ ) = \hat{l} ( {p}_{θ} ; C , λ ) + Φ ( {p}_{θ} ; C , γ , α ) , Φ ( {p}_{θ} ; C , γ , α ) = γ {\sum }_{i = 1}^{N} ( 1 - {( 2 {p}_{θ , i} - 1 )}^{α} ) & ( 21 )\end{matrix}$$

“λ” is a parameter for controlling the loss term in the above formula (21), and is a hyper parameter for controlling the degree of continuity and discreteness. For example, in the following formula (22), when γ is negative, the relaxation variable pe prefers the half-integral value ½, and when γ is positive, the relaxation variable pe prefers the binary value {0, 1}.

$$\begin{matrix}[ Formula 22 ] & \\ α ∈ \{ 2 n + 1 \vert n ∈ ℕ ) , γ & ( 22 )\end{matrix}$$

As machine learning progresses, the hyper parameter λ is gradually changed from a negative value λ⁽⁰⁾<0 to a positive value λ^{(T)}>0. As a result, the loss term changes from one in which the loss is smaller the more continuous the discrete vector p is to one in which the loss is larger the more continuous the discrete vector p is. For example, if λ is −∞, the output solution is ½. If λ is +∞, the output solution is a discrete variable of 0 or 1. This method is sometimes called the continuous relaxation annealing method. By controlling in this way, machine learning ends when the discrete vector becomes almost a discrete value.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various change, substitutions, and alterations could be made hereto without departing from the spirit and scope of the invention.

What is claimed is:

1. A non-transitory computer-readable medium storing a calculation program for causing a computer to execute a process, the process comprising:
in searching for a solution using a cost function and a penalty term obtained by introducing continuous relaxation into a discrete optimization problem, changing a penalty coefficient of the penalty term by using a gradient of the cost function and a gradient of the penalty term.

2. The non-transitory computer-readable medium according to claim 1,
wherein the penalty coefficient is varied so that the cost function and the penalty term decrease by using the gradient of the cost function and the gradient of the penalty term.

3. The non-transitory computer-readable medium according to claim 1,
wherein the process comprises using a loss term according to a degree of continuity or discreteness of variables to be optimized in the cost function, and changing the loss term according to a progress of the searching.

4. The non-transitory computer-readable medium according to claim 3,
wherein as the searching progresses, the loss term is changed from one that causes less loss the more continuous the variable is to one that causes more loss the more continuous the variable is.

5. The non-transitory computer-readable medium according to claim 1,
wherein the process comprises machine-learning a model in which the discrete optimization problem is embedded by repeating steps of: changing the penalty coefficient of the penalty term; changing a model parameter of the model; and calculating the cost function and the penalty term.

6. A calculation method implemented by a computer, the method comprising:
in searching for a solution using a cost function and a penalty term obtained by introducing continuous relaxation into a discrete optimization problem, changing a penalty coefficient of the penalty term by using a gradient of the cost function and a gradient of the penalty term.

7. The method according to claim 6,
wherein the penalty coefficient is varied so that the cost function and the penalty term decrease by using the gradient of the cost function and the gradient of the penalty term.

8. The method according to claim 6, further comprising:
using a loss term according to a degree of continuity or discreteness of variables to be optimized in the cost function, and changing the loss term according to a progress of the searching.

9. The method according to claim 8,
wherein as the searching progresses, the loss term is changed from one that causes less loss the more continuous the variable is to one that causes more loss the more continuous the variable is.

10. The method according to claim 6, further comprising:
machine-learning a model in which the discrete optimization problem is embedded by repeating steps of: changing the penalty coefficient of the penalty term; changing a model parameter of the model; and calculating the cost function and the penalty term.

11. An information processing device comprising:
a memory; and
a processor coupled to the memory and the processor configured to execute a process, the process comprising:
in searching for a solution using a cost function and a penalty term obtained by introducing continuous relaxation into a discrete optimization problem, changing a penalty coefficient of the penalty term by using a gradient of the cost function and a gradient of the penalty term.

12. The information processing device according to claim 11,
wherein the penalty coefficient is varied so that the cost function and the penalty term decrease by using the gradient of the cost function and the gradient of the penalty term.

13. The information processing device according to claim 11,
wherein the process comprises using a loss term according to a degree of continuity or discreteness of variables to be optimized in the cost function, and changing the loss term according to a progress of the searching.

14. The information processing device according to claim 13,
wherein as the searching progresses, the loss term is changed from one that causes less loss the more continuous the variable is to one that causes more loss the more continuous the variable is.

15. The information processing device according to claim 11,
wherein the process comprises machine-learning a model in which the discrete optimization problem is embedded by repeating steps of: changing the penalty coefficient of the penalty term; changing a model parameter of the model; and calculating the cost function and the penalty term.
